(19) United States
(12) Patent Application Publication
(10) Pub. No.: US 2018/0009555 A1
(43) Pub. Date: Jan. 11, 2018

(54) METHOD FOR SEPARATING PORTIONS OF A FOOD MASS

(71) Applicant: Hochland SE, Heimenkirch (DE)

(72) Inventors: Roland Zeuschner, Argenbuhl (DE); Andreas Erd, Simmerberg (DE)

(73) Assignee: Hochland SE, Heimenkirch (DE)

(21) Appl. No.: 15/713,197

(22) Filed: Sep. 22, 2017

Related U.S. Application Data
(63) Continuation of application No. 14/410,255, filed on Dec. 22, 2014, now abandoned.

(30) Foreign Application Priority Data
Jun. 29, 2012 (DE) 102012105749.4

(51) Int. Cl. B65B 9/12; B65B 9/207; A23C 19/08; B65B 9/20; B65B 57/00; B65B 9/213

(52) U.S. Cl. CPC B65B 9/12; B65B 57/00; B65B 9/213; A23C 19/08; B65B 9/2042; B65B 9/207

(57) ABSTRACT

A method for separating portions of a food mass (3) from a film tube (1), which is continuously advanced along a tube-conveying path (9) at belt-running speed and is filled with the food mass, in particular with processed cheese (3), wherein the film tube filled with the food mass (2) is initially formed into a band of defined thickness by means of a pair of calibrating rollers, and wherein, in order to form separate food portions (3), the food mass is then displaced, by means of a pair of displacement rollers acting upon one another, out of displacement regions (2) extending transversely across the film tube, wherein the displacement rollers are driven by means of a drive, which is controllable in terms of the running thereof, in a manner decoupled from the belt-running speed.

The invention relates to a method and a device for separating portions of a food mass from a film tube, which is continuously advanced along a tube-conveying path at belt-running speed and is filled with the food mass, in particular with processed cheese, wherein the film tube filled with the food mass is initially formed into a band of defined thickness by means of a pair of calibrating rollers and wherein, in order to form separate food portions, the food mass is then displaced, by means of a pair of displacement rollers acting upon one another, out of displacement regions extending transversely across the film tube. A transverse sealing for closing the individual slices is subsequently implemented in the displacement regions. Finally, the individual slices are separated from the chain by means of cuts in the transverse seal.

Such methods have been known for a long time from the production of individually packaged processed-cheese slices (“IWS”, “individual wrapped slices”) and are described, for example, in DE 42 04 357 A1 and U.S. Pat. No. 5,112,632. According thereto, a film tube is initially formed from a film and is sealed on the longitudinal seam. This film tube is filled with the food mass and is initially rolled to form a band. The food mass is separated into individual portions by displacement, either in the state while still hot (“hot displacement”) or in the cooled state (“cold displacement”). The displacement regions are subsequently closed in a sealing manner by means of a transverse sealing tool and are finally cut into individual portions.

The displacement tool either has two displacement belts, which move in synchronism when in contact with the product tube, or a plurality of displacement rollers, wherein displacement belts or displacement rollers are provided with displacement webs, by means of which the displacement pressure is applied onto the filled tube. The displacement webs roll on the film tube during displacement. As is known, the displacement tools are operated at a peripheral speed that is constant and, above all, is synchronized with the belt-running speed by means of mechanical coupling. The geometry of the displacement tool and of the displacement webs therefore must be adapted to the size of the food slices to be produced.

In the known displacement tools, the separation between the displacement webs defines the separation between the displacement regions. In these devices, it is either not possible, or is made possible only with a great deal of retrofitting, to change the slice size in the cheese-band running direction or to spontaneously adjust the slice size in accordance with changes in the production parameters. In the fixed correlation of belt-running speed and transverse displacement, it is also possible to react only in a mechanical manner to process-related changes, for example, to a lengthening of the film. Such a mechanical adjustment is complex and entirely inflexible, however.

Such a device is also disclosed, for example, in DE 196 20 560. In this case as well, the size of the slices is predetermined by a displacement station having displacement webs disposed at fixed intervals on a belt. Due to the fixed separation between the displacement regions, a correlation of all downstream rollers, which are equipped with tools engaging into the displacement regions, with the belt speed is absolutely necessary.

The problem addressed by the present invention is therefore that of providing a method for portioning a food mass in a film tube, which is continuously advanced along a tube-conveying path and is filled with food mass, which has a simple design and offers a great deal of flexibility in terms of making the transverse displacement zone and, correspondingly, the transverse sealing. A further problem addressed is that of creating a simply and cost-effectively designed device for implementing the method, which can produce differently spaced displacement regions and, therefore, variable packaging sizes using the same displacement tool.

These problems are solved by the method according to claim 1 and the device according to claim 9. Particular embodiments of the invention are set forth in the respective dependent claims.

A significant fundamental idea of the invention initially relates to the decoupling of the transverse displacement procedure and the transverse sealing procedure from the belt-running speed. This is achieved according to the invention by virtue of the fact that the displacement rollers, which, in one advantageous embodiment, also implement the transverse sealing, are driven in a manner decoupled from the belt-running speed and, therefore, are driven in any functional interrelationship therewith by means of a drive, which is controllable in terms of the running thereof, in particular in terms of the angle of rotation and the speed of rotation. Such a drive can be implemented by means of stepper motors or by servo motors. Whereas, in a stepper motor, the field rotates in a stepped manner and the shaft moves accordingly in defined individual steps, the position, speed and/or torque of the servo drive is controlled by means of a closed-loop control system. The invention makes use of the fact that such motors can be used to set any motion profile independently of external factors, and that the motion profile can also be set with any dependencies on external parameters, which are due to sensors, in particular. Given that a decoupling of the transverse displacement procedure and of the transverse sealing procedure takes place, these steps can be adjusted in any way relative to the advantageously continuous belt-running speed. It must ensured, of course, that the transverse displacement and the transverse sealing correlate to the extent that sealing must also be carried out in the displacement regions, which, in the simplest case, can take place quasi simultaneously by means of a combination of a transverse displacement roller and a transverse sealing roller.

At this point, it is emphasized that the feature “roller” also refers to rollers, in the following, that are guided by means of a belt. A displacement roller can therefore also be formed by a smooth roller, by means of which a belt comprising displacement webs is guided. A decisive point, however, is that only one single pair of displacement webs is ever engaged with the film tube filled with the food mass, thereby ensuring that any separation between the successive displacement regions can be implemented. A plurality of roller pairs disposed one behind the other could also be used for displacement.

By means of such drives it is possible to operate the displacement rollers with a dependency on the belt-running speed that is adjustable, but which is fixed during the production of a lot, or with predetermined, individual rotation characteristics. When these drives are used, each lot can be run with a different motion profile, for example, in order to produce slices having different dimensions; it is even possible to produce slices having different dimensions in the course of a lot. The dimensions of the slices to be produced can be programmed, in principle, in a fully flexible manner in advance using such drives, thereby ensuring that a program controls the roller drive and, therefore, the application of the displacement webs; in the simplest case, the application of the displacement webs is defined by a time period, which is specified by the program and can be adjusted, thereby ensuring that the displacement rollers can be controlled with specifiable rotation characteristics by means of a computer program that implements timing.

Rather than by means of such a time period, the displacement webs can also be set down under the control of sensors, which monitor the progress of the film tube. By means thereof, and by means of the separate drive, it is possible, in particular, to operate the displacement rollers in correlation with a detectable pattern on the film tube, i.e., to correlate the displacement with the actual belt advancement. The pattern can be printed on the film in the manner of a pattern mark specifically for the purpose of detection and synchronization. It can also be a distinctive point in one printed image in a series of recurrent images, which is used to implement synchronization. Synchronization can also be implemented on the basis of recurrent recesses or impressions in the film that can be detected optically or by means of contact. In this embodiment, the displacement rollers are controlled in correlation with a sensor signal by means of a computer program, wherein the sensor signal correlates with a detectable pattern on the film tube.

The synchronization with such a “mark” then comprises the following method steps of: detecting a defined part of a printed and/or embossed pattern, in particular an optically and/or tactilely detectable pattern mark, on the film tube by means of a sensor, which can be designed, in particular, as an optical and/or contact sensor; operating the (pair of) displacement rollers in a manner dependent on the detection of the defined part of the printed pattern such that the food mass is displaced out of the tube at a predetermined distance from the defined part of the printed pattern. According to the invention, the displacement and the subsequent sealing are synchronized with the film printing or embossing, in particular with the pattern mark, and are implemented in the spaces between packages so as to be centered between pattern marks.

The idea, therefore, is that the function and the activity of the displacement rollers and, therefore, the displacement of the food mass itself is brought into dependence with that which is detected by the sensor. For example, the sensor detects the pattern on the film tube, which is located at a previously defined distance from the displacement region. On the basis of the time and location of the pattern mark upon detection by the sensor, and on the basis of the conveyance speed of the film tube, it is now possible to determine the time at which the region of the film tube where a displacement should take place (the displacement region) will enter the active region of the displacement tool. The displacement rollers are then adjusted such that the displacement takes place exactly at this time (the displacement time). The displacement rollers can be driven by a (stepper or) servo motor, in particular, which can bring the displacement rollers into an appropriate position exactly at the displacement time. At the displacement time, it can also be ensured by the (?) stepper motor that the peripheral speed of the displacement rollers corresponds to the conveyance speed of the tube. In the time period between two subsequent displacement times, the displacement rollers can be brought to a higher or lower peripheral speed in order to compensate for differences between the separation between two downstream displacement regions and between two downstream displacement surfaces.

Further, on the basis of the above-described interaction, the function of the displacement rollers can be brought at least indirectly into dependence with a cut pattern on the longitudinal edge of the film forming the tube. The cut pattern can form tear-open tabs on the finished package. The tear-open tabs should be centered on a cheese slice or on the exact package of a cheese slice, of course, which can be achieved by means of the method. The synchronization with the shape of the film can also be implemented on the basis of patterns that are not printed, which also applies to the entire invention. For example, the pattern can also be formed by a workpiece edge, e.g., a corner of the cut pattern, or the like.

The invention further comprises a device for separating portions of a food from a film tube, which is continuously advanced along a tube-conveying path and is filled with a food mass, in particular with a hot melted cheese, wherein, in order to form separate food portions, displacement rollers are provided for displacing the food mass out of a displacement region and. According to the invention, the device comprises a drive, which is controllable in terms of the running thereof, in particular a stepper motor or a servo drive, which permits a drive of the displacement rollers which is decoupled from the belt-running speed and correlates with a timing and/or a sensor signal.

In one particularly advantageous embodiment of the invention, means are provided for guiding the film tube along the tube-conveying path, and a sensor is provided for detecting a defined part of an embossed or printed pattern, in particular a pattern mark, on the film tube, or of a recess in the film tube. The control of the displacement rollers is managed by a controller, which controls the displacement rollers in a manner dependent on a signal generated by the sensor such that the food mass is displaced out of the film tube at a predetermined distance from the defined part of the printed pattern or the recess.

The invention is explained in greater detail in the following with reference, wherein

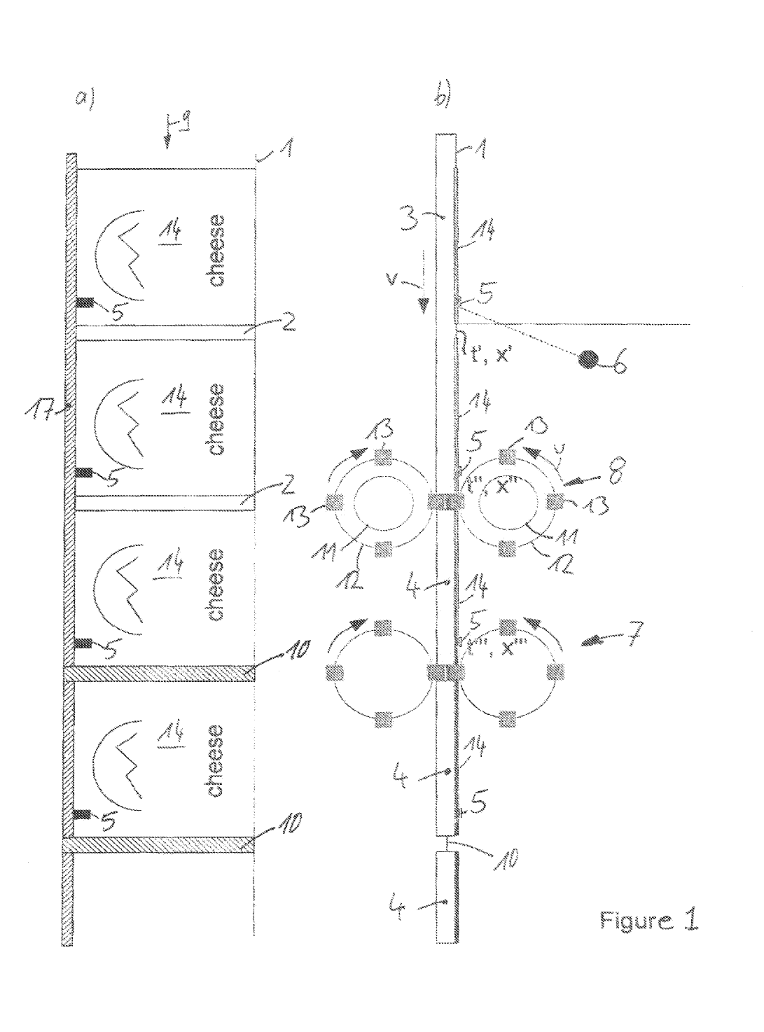

FIG. 1 shows a schematic depiction of a device for implementing the method according to the invention
a) in a top view, without a depiction of tools,
b) in a side view;

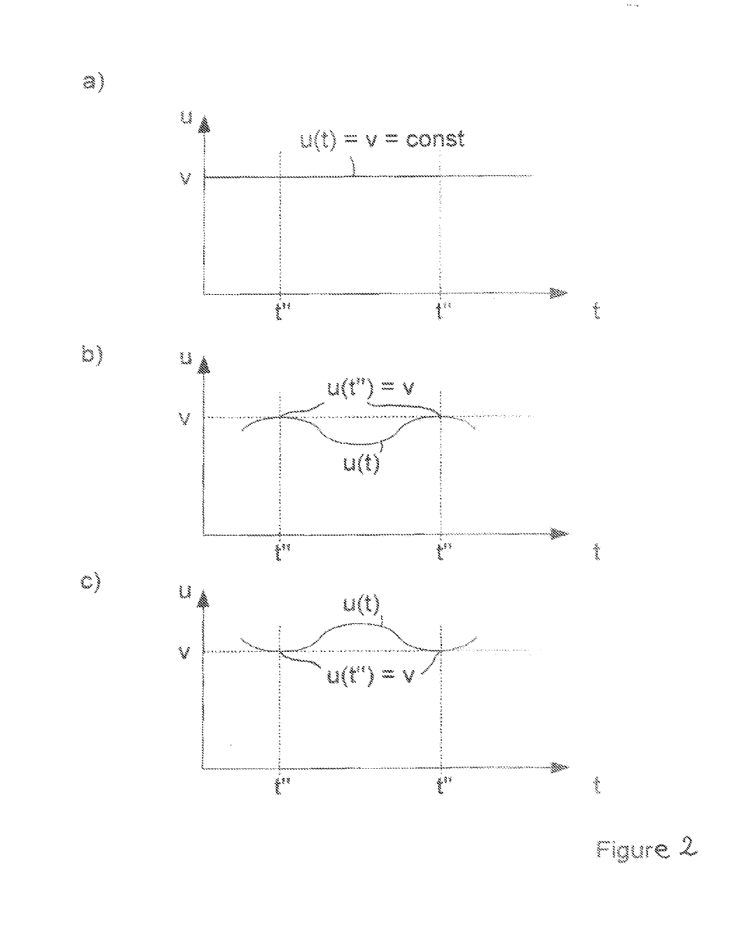

FIG. 2 shows the course of the speed of a displacement roller for each of the cases, in which
a) the separation between two displacement surfaces is equal to the separation between two displacement regions,
b) the separation between two displacement surfaces on the periphery of the displacement roller is greater than the separation between two displacement regions on the tube,
c) the separation between two displacement surfaces on the periphery of the displacement roller is less than the separation between two displacement regions on the tube;

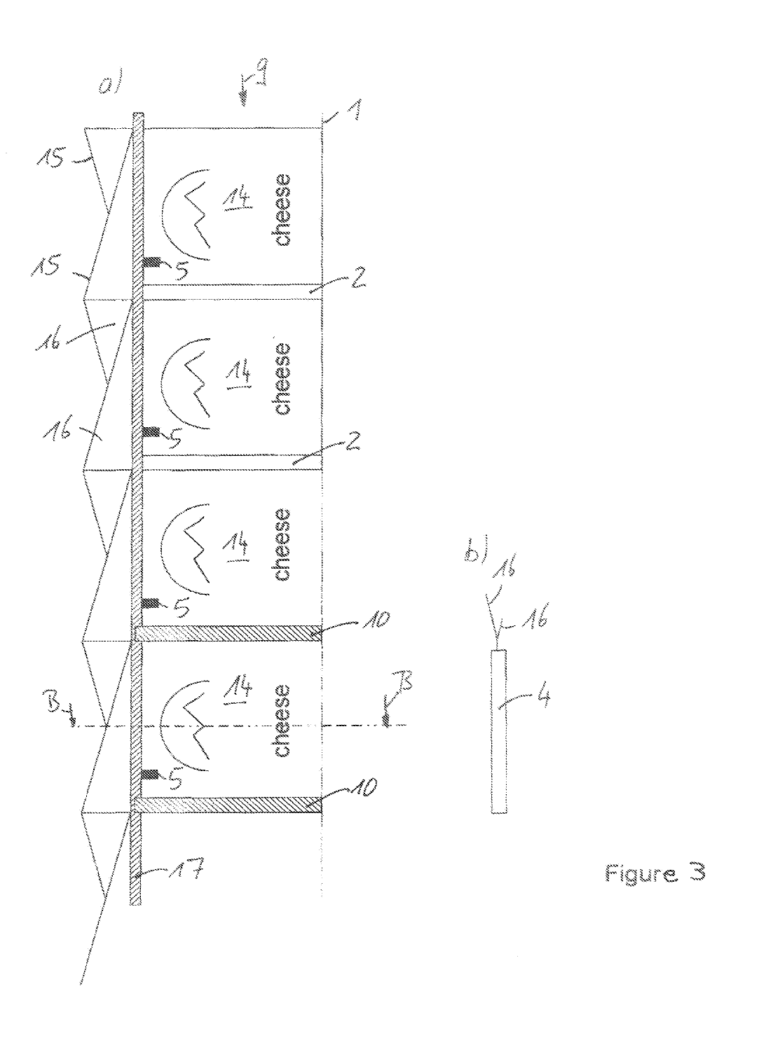

FIG. 3 a) shows the device according to FIG. 1a) with a product film having a contour cut on one side or both sides, on the longitudinal side of the film,
b) shows a completed package having tear-open tabs, in the cross section along the line of cut B-B according to FIG. 3a).

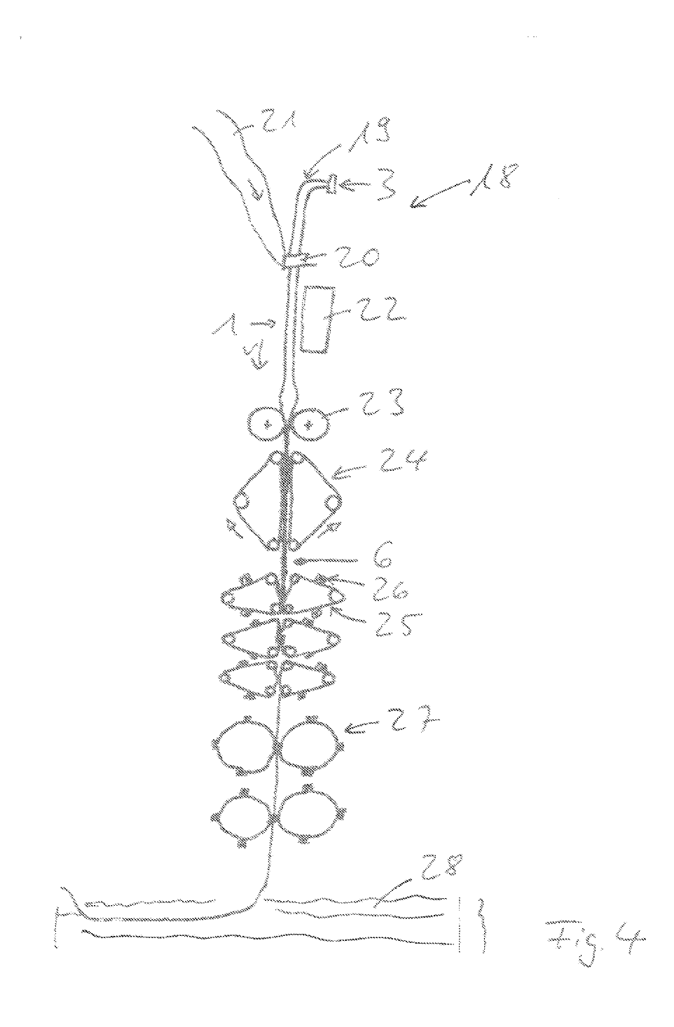

FIG. 4 shows a production device comprising a device for implementing the method according to the invention.

FIG. 1 shows a film tube 1 during the method according to the invention. The film tube 1 is guided along a tube-conveying path 9 by non-illustrated guide means. It is filled with a processed-cheese mass 3, wherein the processed-cheese mass packaged in the film tube is separated to form individually packaged slices. At the end of the method, individually packaged cheese slices of a certain size are, wherein any length of the slices can be set (even while the operation is underway) by means of the device according to the invention, but the width is predetermined by the film tube. In the present exemplary embodiment, every package is provided with an image 14, which comprises a logo and product information in text form and is centered exactly on the package.

Each image 14 has a pattern mark 5, which is detected by a sensor 6. A displacement region 2 is defined at a defined distance from the pattern mark 5, onto which displacement rollers 8, 12 are set in order to displace the processed cheese out of the displacement region 2. When the sensor 6 detects the pattern mark 5, the displacement region 2 is located at a location x′ at the time t′ of the detection. On the basis of the constant conveyance speed v of the tube 1, it is then possible to calculate a displacement time t″ at which the displacement region 2 is disposed at a location x″ along the conveyance path 9, at which a displacement is then carried out by means of the displacement rollers 12. The displacement surfaces 13 on the displacement rollers 12 are moved toward one another by means of rotation and pinch the film tube 1 there in order to displace the processed cheese 3 out of the displacement region 2. The processed cheese 2 is thereby portioned into individual cheese slices 4.

Next, the tube 1 is sealed in the region of the displacement region 2 by means of a transverse sealing tool 7 comprising transverse sealing rollers. The individual slices can be separated later by means of a transverse cutting in the sealed regions 2, for example, by means of a device of the type described in WO 2008/119633 A1.

Therein, it is necessary that the displacement surfaces 13 be moved, at time t″ at location x″, at a peripheral speed u that correspond to the conveyance speed v of the tube 1. FIG. 2a shows a speed diagram in which the peripheral speed u of the displacement surfaces 13 is identical to the conveyance speed v. This is possible when the displacement regions 2 of the tube 1 have a separation between one another that corresponds to the peripheral separation between two adjacent displacement surfaces 13. The displacement surfaces 13 can then roll on the tube at a constant peripheral speed without sliding. It is assumed that the conveyance speed v of the tube 1 is constant.

If the separation between two adjacent displacement regions 2 is greater than the peripheral separation between two adjacent displacement surfaces 13, however, the speed of the displacement roller 12 must be reduced between the individual displacement steps in order to prevent the displacement regions 2 from being “outstripped” by the displacement surfaces 13. It is further provided, however, that the peripheral speed u of the displacement roller 12 still corresponds to the conveyance speed v of the tube 1 during the displacement time t″, in order to 1 prevent the tool 12 from sliding on the tube. The wave-shaped course shown in FIG. 2b therefore results, which, on average, is less than the conveyance speed of the tube 1, however, and is implemented by the control of the servo motor 11.

For the case in which the separation between two adjacent displacement regions 2 is less than the peripheral separation between two adjacent displacement surfaces 13, the speed of the displacement roller 12 must be increased between the individual displacement steps in order to conversely prevent the displacement surfaces 13 from being “outstripped” by the displacement regions 2. In this case as well, the peripheral speed u of the displacement roller 12 still corresponds to the conveyance speed v of the tube 1 during the displacement time t″, in order to prevent the tool 12 from sliding on the tube 1. The wave-shaped course shown in FIG. 2c therefore results, which, on average, is greater than the conveyance speed of the tube 1, however, and is implemented by the control of the servo motor 11. The downstream sealing rollers 27 (FIG. 4) undergo a corresponding control at a another, corresponding, time t′″ and at another location x′″.

Due to the invention, it is now possible to flexibly implement any separation between displacement regions 2 without the need to retrofit the device used for the displacement. To this end, all that is required is either an adjustable timing of the displacement and sealing, or a pattern mark 5 is identified on the tube, which is detectable by a sensor and is always disposed at a predetermined distance from the desired displacement region. It is also possible, for example, to easily switch to different distances between the displacement regions 2 simply by changing the timing and/or the distances between the pattern marks. A reliable synchronization of the displacement rollers 8 with the image printed on the tube or with other markings, in particular, is thereby achieved. It is hereby made possible for the first time to provide packages having exactly one processed-cheese slice with an image that is centered on the package.

A further possible application is explained with reference to FIG. 3. The film forming the tube 1 has a serrated pattern 15 on one or both longitudinal edges. In the completed tube 1, the serrated pattern 15 then extends over the longitudinal sealing seam 17 such that tear-open tabs 16 extend beyond the longitudinal sealing seam 17. The tear-open tabs 16 are fully exposed and can be gripped individually by the end user and pulled apart from one another in order to open the package. The pattern mark 5 is synchronized with the serrated pattern 15. One cheese slice 4 is therefore separated out of the processed-cheese mass 3 by means of the synchronization of the displacement rollers 8 with the pattern mark 5, which is oriented with respect to the serrated pattern 15 and, therefore, the tear-open tabs 16. It is not necessary for the displacement rollers 8 and the transverse sealing tool 7 to act across the entire width of the film and can, instead, omit the region of the tear-open tabs 16.

FIG. 4 shows a schematic depiction of a production line 18 for producing individually packaged cheese slices, which is suitable for the device of the method according to the invention. Melted, flowable processed cheese 3 is supplied via a supply nozzle 19 in the upper region. At a shaped projection 20, tube film 21, which is still flat when initially advanced, is wrapped around the supply nozzle 19 in a “U” shape. The longitudinal edges of the tube film, which come to lie one on top of the other due to V-shaped arrangement, are sealed in a downstream longitudinal sealing unit 22, thereby producing the continuous longitudinal sealing edge 17 (FIG. 1a). The film tube 1 is thereby produced.

Downstream thereof, the film tube 1 filled with processed cheese 3 passes two oppositely rotating calibration rollers 23, by means of which the slice thickness of the processed-cheese slices 4 is set. Two downstream conveyor belts 24 clamp the filled film tube 1 between themselves. By means of a tension force, which the conveyor belts 24 apply onto the film tube, said film tube is held taut in the region above the conveyor belts 24 and is conveyed further downward. In another embodiment, the conveyor belts 24 can also be mounted underneath the displacement and sealing tools. The conveyor belts 24 ensure that the film tube 1 is brought to a desired conveyance speed, which is a necessary prerequisite for the function of the displacement rollers. An optical sensor 6 detects the pattern marks or other patterns on the film tube 1.

The displacement rollers are provided downstream of the conveyor belts 24. In this case, in deviation from the exemplary embodiment according to FIG. 1, these are embodied as three successively disposed pairs of ribbed conveyor belts 25, which are provided with webs 26 oriented transversely to the conveyance direction. The webs 26 form the displacement surfaces 9 in a manner analogous to the displacement rollers 12 according to FIG. 1 and can likewise displace processed-cheese mass 3 out of the regions of the tube 1. During the displacement, the webs 26 are operated at the peripheral speed u, which corresponds to the conveyance speed v of the tube. Two pairs of transverse sealing rollers 27 are provided downstream thereof, in the conveyance direction, which transversely seal the tube film in the displacement regions 2. The function of the ribbed conveyor belts 25 and the transverse sealing rollers 27 is analogous to the function of the corresponding elements of the exemplary embodiment according to FIG. 1 and FIG. 2. Next, the tube 1 passes through a cooling water bath 28, thereby cooling the newly formed individual slices of processed cheese.

The two method steps are synchronized with a printed and/or embossed surface due to the use of the displacement and sealing centered with respect to the pattern mark (or centered with respect to another mark). It is therefore possible to place the displacement and the transverse sealing so as to be centered between the printed images. Synchronization with the image printed on the film is therefore possible due to the drive of the displacement and transverse sealing tools according to the invention. The drive further makes it possible to switch to any slice lengths within a specified range, even during the operation, without changing tools, which is suitable, in particular, for films that are unprinted or are printed by means of scatter printing. The device according to FIG. 1 can be easily installed in the production device according to claim 4, as a replacement for corresponding units shown in FIG. 4.

### LIST OF REFERENCE SIGNS

1 tube
2 displacement region
3 processed cheese
4 cheese slice
5 pattern mark
6 sensor
7 transverse sealing tool
8 displacement tool
9 tube-conveying path
10 transverse sealing seam
11 stepper motor
12 displacement roller
13 displacement surface
14 image
15 serrated pattern
16 tear-open tab
17 longitudinal sealing seam
18 production machine
19 supply nozzle
20 shaped projection
21 tube film
22 longitudinal sealing unit
23 rollers for calibration
24 conveyor belts
25 ribbed conveyor belts
26 webs
27 transverse sealing rollers
28 cooling water bath
x position along the tube-conveying path
t time
v conveyance speed of the tube
u peripheral speed of the displacement surfaces

1. A method for separating portions of a food mass (3) from a film tube (1), which is continuously advanced along a tube-conveying path (9) at belt-running speed and is filled with the food mass, in particular with processed cheese (3), wherein the film tube filled with the food mass (2) is initially formed into a band of defined thickness by means of a pair of calibrating rollers, and wherein, in order to form separate food portions (3), the food mass is then displaced, by a pair of displacement rollers having displacement webs (26) acting upon one another, out of displacement regions (2) extending transversely across the film tube,
wherein
the displacement rollers are driven by a drive, which is controllable in terms of the running thereof, in a manner decoupled from the belt-running speed.

2. The method according to claim 1,
wherein
the displacement rollers are controlled with specifiable rotation characteristics by means of a computer program, which implements timing.

3. The method according to claim 1,
wherein
the displacement rollers are controlled by a computer program in correlation with a sensor signal, wherein the sensor signal correlates with a detectable pattern on the film tube.

4. The method according to claim 3,
wherein
the method further comprises:
detecting a defined part (5) of a pattern provided on the film tube (1) via a sensor (6),
operating the displacement rollers (8) in a manner dependent on the detection of the defined part (5) of the pattern such that the food mass (2) is displaced out of the film tube (1) in a displacement region at a predetermined distance from the defined part (5) of the pattern,

5. The method according to claim 4,
wherein
on the basis of the position (x′) of the defined part (5) along the tube-conveying path (9) and
on the basis of the time (t′) of the detection of the mark (5), a displacement time (t″) is determined, at which the displacement rollers (8), with the displacement webs thereof, are brought into displacing contact with the tube (1).

6. The method according to claim 1,
wherein
a transverse sealing seam (10) is produced in the displacement region (2) after the food mass (3) was displaced out of the displacement region (2).

7. The method according to claim 1,
wherein
a contour cut (15) on a longitudinal edge (17) of a film, which forms the film tube (1), for forming tear-open tabs (16) on the finished package is synchronized, at least indirectly, with the displacement rollers (7) and/or the transverse sealing rollers.

8. A device for separating portions of a food (3) from a film tube (1), which is continuously advanced along a tube-conveying path (9) and is filled with a food mass, in particular with processed cheese (3), wherein, in order to form separate food portions, displacement rollers (7) are provided for displacing the food mass (3) out of a displacement region (2),
wherein
a drive, which is controllable in terms of the running thereof is provided for driving the displacement rollers that is decoupled from the belt-running speed.

9. The device according to claim 8 further comprising
a computer program for controlling the displacement rollers in correlation with a sensor signal and/or in correlation with a timing.

10. The device according to claim 8 further comprising
conveyor belts (24), for guiding the film tube (1) along a tube-conveying path (9),
a sensor (6) for detecting a defined part (5) of an embossed or printed pattern on the film tube (1), or of a recess in the film tube,
a controller for controlling the servo drive (11) in a manner dependent on a signal generated by the sensor (6) in order to displace the food mass (2) out of the film tube (1) at a predetermined distance from the defined part (5) of the printed pattern or the recess.
